(19) United States
(12) Patent Application Publication
(10) Pub. No.: US 2026/0292436 A1
(43) Pub. Date: Sep. 24, 2026

(54) VIRTUAL ENVIRONMENT SCALING USING AUDIO ZONING

(71) Applicant: Meta Platforms Technologies, LLC, Menlo Park, CA (US)

(72) Inventors: Pierre Seigneurbieux, Mountain View, CA (US); Kent Jolly, Oakland, CA (US); Peter James Alexander, Maidstone (GB); Vamsi Mynampati, San Francisco, CA (US); Mihnea Razvan Olteanu, Kirkland, WA (US)

(21) Appl. No.: 19/087,006

(22) Filed: Mar. 21, 2025

(51) Int. Cl. H04S 7/00; H04S 3/00

(52) U.S. Cl. CPC H04S 7/304; H04S 3/008; H04S 2400/01; H04S 2400/11; H04S 2400/15; H04S 2420/11

(57) ABSTRACT

An embodiment includes rendering, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources. An embodiment includes generating, at the local device, an outgoing audio stream comprising audio collected from a collocated audio source, the collocated audio source collocated with a user for which the local device renders the local audio stream and the neighboring audio stream. An embodiment includes sending, to the local audio mixer, the outgoing audio stream.

### TECHNICAL FIELD

The present disclosure generally relates to virtual environment implementation, and more particularly to virtual environment scaling using audio zoning.

### BACKGROUND

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.” “Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

A virtual environment, or virtual world, or virtual space, is an MR environment that can be populated by simultaneous users who are able to independently explore the virtual environment, participate in its activities, and communicate with other users of the virtual environment. Users typically experience the virtual environment using an MR headset (displaying a three-dimensional environment populated by users or their avatars) or a mobile device or another computer system (displaying a two-dimensional rendering of the virtual three-dimensional environment). A virtual environment is also a physical environment that a user experiences via an MR headset or a mobile device or another computer system. Because a virtual environment is an MR environment, a virtual environment can include both physical and virtual portions (e.g., an MR headset, mobile device, or hearing assist device used to provide virtual audio while in a physical concert hall).

Real-time virtual environments allow users to interact and communicate via audio. Traditional audio implementations within virtual environments are one-to-one, thus allowing a finite number of users to connect and communicate, the number of connections being capped by how many users a server can host or how many connections each client can sustain in case of peer-to-peer connections between clients. In most virtual environments, such as gaming platforms, the scale is handled by sharding servers, allowing millions of users to play at the same time, but not truly allowing users to be part of a single world, as each shard creates an instance of a world when only a finite number of users can play and interact. For example, users might attend a virtual concert or sports game, but due to the lack of scaling only up to a few hundreds of people can be connected together, preventing a user from hearing aspects of the crowd environment such as cheers, boos, or singing along to a singer on stage.

One presently available solution is the rendering of a generated crowd, allowing users to get a feeling of being part of a bigger crowd. However, because the surrounding audio is generated rather than collected, the crowd audio is not in sync with what users see. As an example, in a virtual stadium watching a soccer game, a user will not be able to feel the difference between part of the crowd cheering for the home team, while other fans boo. As well, specific events such as scoring a goal trigger specific sounds that are difficult to generate realistically.

Thus, the illustrative embodiments recognize that there is a need for an audio solution for virtual environments that scales to crowds larger than a few hundred users and accommodates user movement in the virtual environment.

### SUMMARY

Some embodiments of the present disclosure provide a computer-implemented method for virtual environment scaling using audio zoning. The method includes rendering, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources; generating, at the local device, an outgoing audio stream comprising audio collected from a collocated audio source, the collocated audio source collocated with a user for which the local device renders the local audio stream and the neighboring audio stream; and sending, to the local audio mixer, the outgoing audio stream.

Some embodiments of the present disclosure provide a non-transitory computer-readable medium storing a program for virtual environment scaling using audio zoning. The program, when executed by a computer, configures the computer to render, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources; generate, at local device, an outgoing audio stream comprising audio collected from a collocated audio source, the collocated audio source collocated with a user for which the local device renders the local audio stream and the neighboring audio stream; and send, to the local audio mixer, the outgoing audio stream.

Some embodiments of the present disclosure provide a system for virtual environment scaling using audio zoning. The system comprises a processor and a non-transitory computer readable medium storing a set of instructions, which when executed by the processor, configure the processor to render, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources; generate, at the local device, an outgoing audio stream comprising audio collected from a collocated audio source, the collocated audio source collocated with a user for which the local device renders the local audio stream and the neighboring audio stream; and send, to the local audio mixer, the outgoing audio stream.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement virtual environment scaling using audio zoning, according to some embodiments.

FIG. 2 is a block diagram illustrating details of a system for virtual environment scaling using audio zoning, according to some embodiments.

FIG. 3 depicts a block diagram of an example configuration for virtual environment scaling using audio zoning, in accordance with an illustrative embodiment.

FIG. 4 depicts an example configuration of virtual environment scaling using audio zoning, in accordance with an illustrative embodiment.

FIG. 5 depicts another example configuration of virtual environment scaling using audio zoning, in accordance with an illustrative embodiment.

FIG. 6 depicts another example configuration of virtual environment scaling using audio zoning, in accordance with an illustrative embodiment.

FIG. 7 depicts another example configuration of virtual environment scaling using audio zoning, in accordance with an illustrative embodiment.

FIG. 8 depicts a flowchart of an example process for virtual environment scaling using audio zoning. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing virtual environment scaling using audio zoning. In particular, an embodiment renders, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources.

A virtual environment is divided into audio zones, or zones. In some embodiments, zones are predefined and fixed. For example, a virtual farm environment might have comparatively large zones because few users are typically present, while a virtual stadium might have many smaller zones to accommodate an expected crowd. In other embodiments, zones are reconfigurable, by an administrator or automatically by an embodiment, to accommodate user movement within the virtual environment. For example, an area around a virtual stadium might be mostly empty hours before a game or concert, become more crowded as users gather, be full while the game or concert is ongoing, and then return to the mostly empty state, with zones being redefined as user presence in the area meets predefined thresholds. As the zones described herein are defined for audio generation purposes, a zone need not relate to a particular location in a virtual or physical environment. In embodiments, zones are static or dynamic and have particular locations or move with a user (e.g., the user is in one local zone and everyone else in the virtual environment is in another zone, or the user and a group of friends are in one local zone and everyone else in the virtual environment is in another zone).

A local zone is a zone in which a first user (for whom audio is being generated) is present. A local zone typically includes one or more other users the first user interacts with on a one-on-one basis. A non-local zone is a zone in which the user is not present. One example of a non-local zone is a neighbor zone, including one or more other users the first user does not interact with one-on-one, but are still close enough to the user in the virtual environment that the user expects to hear audio from the neighbor zone when experiencing the virtual environment.

A user experiences a virtual environment using a local device such as an MR or VR headset. A local device has a one to-one relationship with a media server. A media server is an end point for an individual client local device, and relays data between a local device and one or more mixers. An embodiment executing at a local device generates an outgoing audio stream including audio collected from an audio source collocated with the user and sends the outgoing audio stream to a local audio mixer. Thus, if multiple users are in the local zone, the local audio mixer receives audio streams from multiple local audio sources such as local devices. Similarly, one or more embodiments executing at neighbor-zone local devices generate outgoing audio streams including audio collected from audio sources collocated with users in the neighbor zone (neighbor audio sources) and send the outgoing audio streams to a neighbor audio mixer.

A neighbor audio mixer generates a neighbor audio mix from the audio streams received from neighbor audio sources. In one embodiment, the neighbor audio mix is a mono mix (i.e., in a monaural or mono format, as if the sound were emanating from one position). A neighbor audio mixer sends the generated mix to one or more other mixers, such as a local mixer, as an audio stream.

A local mixer generates a local audio mix from any received neighbor mixes and local audio sources. In one embodiment, the local audio mix is an ambisonic mix. An ambisonic mix is a sound mix in an ambisonic format, a full-sphere surround sound format that includes sources in the horizontal plane as well as sound sources above and below the listener. The local mixer sends the generated mix, as an audio stream, to an embodiment at a local device of the user. Note that the local mixer can also act as a neighbor mixer for users in the neighbor zone. A local zone served by a local mixer is configurable to have any number of direct neighbors (from zero to the maximum supported by the computing and network capabilities of the systems implementing a virtual environment). A local zone served by a local mixer is also configurable to have one or more indirect neighbors, in which a neighbor mixer mixes audio from its own audio streams with an audio stream received from another neighbor mixer and passes the result to yet another neighbor mixer or to the local mixer.

At the local device of the user, an embodiment renders the local audio stream and the neighbor audio stream. Rendering an audio stream includes spatializing the audio stream, i.e., playing the audio stream as if the stream were positioned at a specific point in three-dimensional space around the user. If a user is wearing a headset or AR glasses with left and right ear inputs, spatializing the audio stream includes generating a left ear input and a right ear input of spatialized audio. If a user's local device includes stereo outputs or multi-channel outputs (e.g., five or more outputs, as in a home theater system), spatializing the audio stream includes generating per-channel outputs of spatialized audio. One embodiment implements a spatialized audio stream in which nearby audio sources are rendered more clearly than more distant audio sources and audio sources a user is looking at are rendered more clearly than audio sources the user is not looking at (e.g., audio sources behind the user). If a user is using an output system with multiple speakers, spatializing the audio stream includes generating suitable outputs from each speaker. Techniques for rendering spatialized audio are presently available. Additional rendering formats are also possible and contemplated within the scope of the illustrative embodiments.

For example, in one use case, a virtual concert, a user might have ten friends in the immediate vicinity. Audio from the ten friends might be implemented as local audio sources sent to a local mixer and thence to the user's local device for rendering. Audio from a group of neighbors to the user's left (e.g., cheering for the singer) is sent from neighbor audio sources to a neighbor mixer, which sends a neighbor mix to the local mixer and thence to the user's local device for rendering. Audio from a group of neighbors to the user's right (e.g., singing along) is sent from neighbor audio sources to another neighbor mixer, which sends another neighbor mix to the local mixer and thence to the user's local device for rendering. As a result, the user can enjoy the concert and talk to the friends, but at the same time, feel immersed in the crowd with real-time, specific feedback such as the set of people on the user's left cheering for the singer while on the user's right people are singing along.

An embodiment detects a change in user position from a first zone including a first plurality of local audio sources towards a second zone including a second plurality of local audio sources. During the detected change in user position, an embodiment executing at a local device renders an existing neighbor audio stream as well as a cross-fade between a first local audio stream (including a first audio mix generated by a first local audio mixer from the first plurality of local audio sources) and a second local audio stream (including a second audio mix generated by a second local audio mixer from the second plurality of local audio sources).

In another example configuration, an embodiment executing at a local device renders a local audio stream described elsewhere herein (e.g., in an audience zone) and a stage audio stream (from a stage zone). The stage audio stream includes an audio mix generated by a stage audio mixer from one or more stage audio sources and outputs from audience mixers mixing local audio sources in each audience zone. This example configuration might be used, for example, for a virtual concert, to ensure that each presenter, singer, or musical instrument on the stage can be heard by audience members while adding enough audio from audience members to produce an “in the audience” experience for a user. The stage zone might be fixed (e.g., incorporating all of the stage or all of a playing field) or move with a presenter (e.g., if the presenter leaves the stage to move around the audience). In another example configuration, an embodiment executing at a local device renders a local audio stream, the stage audio stream, and one or more neighbor mixes (as described elsewhere herein).

In another example configuration, an embodiment executing at a local device renders a plurality of nearest audio streams. Each nearest audio stream includes an audio mix generated by an audio mixer from a plurality of audio sources in a zone of a nearest neighbors to the local device. This example configuration might be used, for example, to implement a virtual environment in which a user moves around and experiences audio from other users that are sufficiently close to the user. For example, if a user is currently in zone 2 and a user's nearest neighbors are in zones 1, 2, 3, and 4, the user's local device might receive mixes from the mixer for zone 1, the mixer for zone 2, the mixer for zone 3, and the mixer for zone 4. One embodiment uses a predetermined zone map. Another embodiment adjusts zone sizes and locations to accommodate users'locations in the virtual environment. For example, an embodiment might shrink a zone's area in a location that is drawing a crowd and might expand a zone's area in a location that currently includes a sparser population.

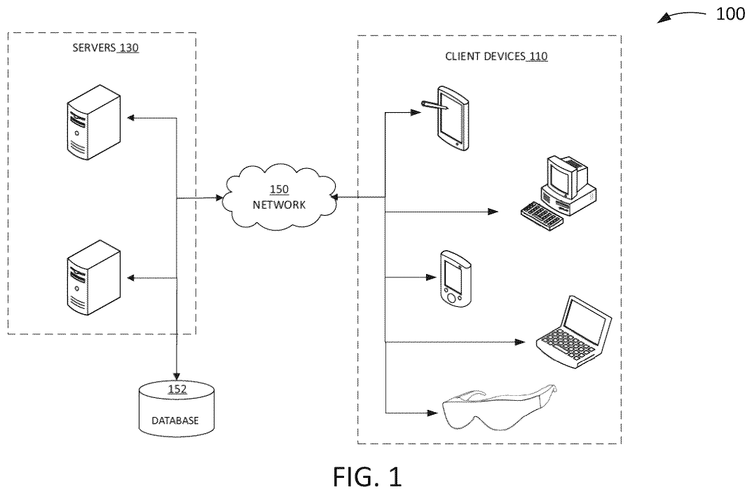

FIG. 1 illustrates a network architecture 100 used to implement virtual environment scaling using audio zoning, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

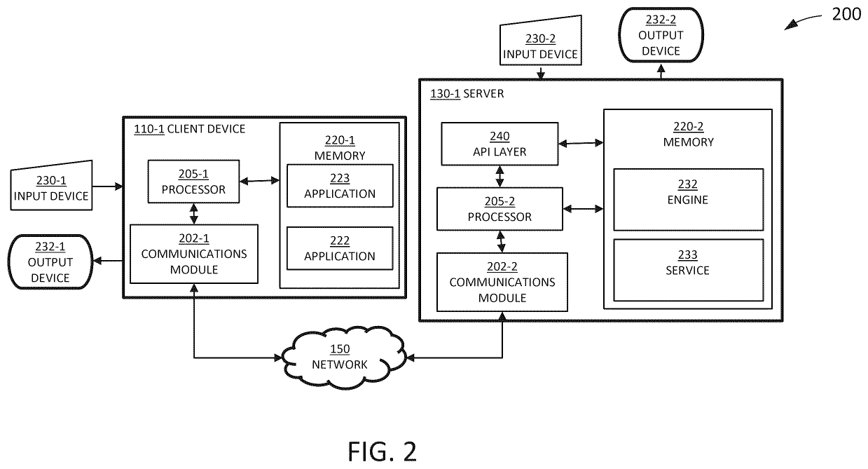

FIG. 2 is a block diagram illustrating details of a system 200 for virtual environment scaling using audio zoning, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement virtual environment scaling using audio zoning. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide virtual environment scaling using audio zoning. The application 223 may communicate with service 233 through API layer 240, for example.

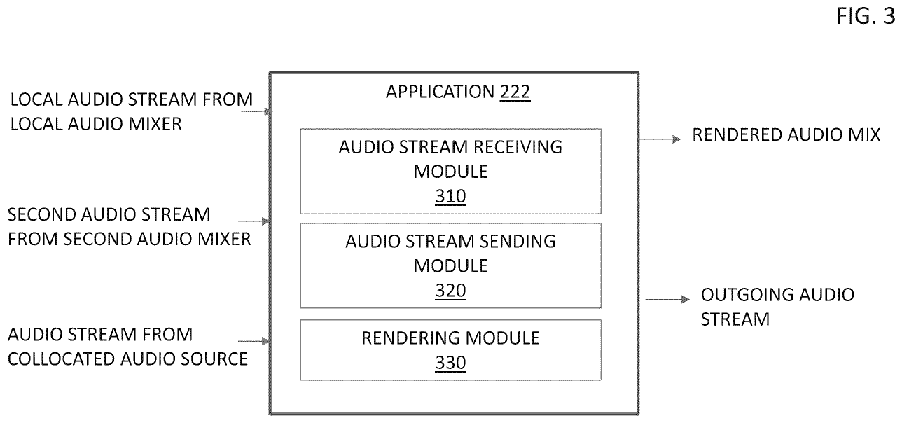

FIG. 3 depicts a block diagram of an example configuration for virtual environment scaling using audio zoning, in accordance with an illustrative embodiment. Application 222 is the same as application 222 in FIG. 2.

A virtual environment is divided into audio zones, or zones. In some implementations of application 222, zones are predefined and fixed. For example, a virtual farm environment might have comparatively large zones because few users are typically present, while a virtual stadium might have many smaller zones to accommodate an expected crowd. In other implementations of application 222, zones are reconfigurable, by an administrator or automatically by an embodiment, to accommodate user movement within the virtual environment. For example, an area around a virtual stadium might be mostly empty hours before a game or concert, become more crowded as users gather, be full while the game or concert is ongoing, and then return to the mostly empty state, with zones being redefined as user presence in the area meets predefined thresholds. As the zones described herein are defined for audio generation purposes, a zone need not relate to a particular location in a virtual or physical environment. In implementations of application 222, zones are static or dynamic and have particular locations or move with a user (e.g., the user is in one local zone and everyone else in the virtual environment is in another zone, or the user and a group of friends are in one local zone and everyone else in the virtual environment is in another zone).

A local zone is a zone in which a first user (for whom audio is being generated) is present. A local zone typically includes one or more other users the first user interacts with on a one-on-one basis. A non-local zone is a zone in which the user is not present. One example of a non-local zone is a neighbor zone, including one or more other users the first user does not interact with one-on-one, but are still close enough to the user in the virtual environment that the user expects to hear audio from the neighbor zone when experiencing the virtual environment.

Audio stream sending module 320, executing at a local device, generates an outgoing audio stream including audio collected from an audio source collocated with the user and sends the outgoing audio stream to a local audio mixer. Thus, if multiple users are in the local zone, the local audio mixer receives audio streams from multiple local audio sources via multiple local devices. Similarly, implementations of module 320 executing at neighbor-zone local devices generate outgoing audio streams including audio collected from audio sources collocated with users in the neighbor zone (neighbor audio sources) and send the outgoing audio streams to a neighbor audio mixer.

A neighbor audio mixer generates a neighbor audio mix from the audio streams received from neighbor audio sources. In one implementation of application 222, the neighbor audio mix is a mono mix (i.e., in a monaural or mono format, as if the sound were emanating from one position). A neighbor audio mixer sends the generated mix to one or more other mixers, such as a local mixer, as an audio stream.

A local mixer generates a local audio mix from any received neighbor mixes and local audio sources. In one implementation of application 222, the local audio mix is an ambisonic mix. An ambisonic mix is a sound mix in an ambisonic format, a full-sphere surround sound format that includes sources in the horizontal plane as well as sound sources above and below the listener. The local mixer sends the generated mix, as an audio stream, to audio stream receiving module 310 at a local device of the user. Note that the local mixer can also act as a neighbor mixer for users in the neighbor zone. A local zone served by a local mixer is configurable to have any number of direct neighbors (from zero to the maximum supported by the computing and network capabilities of the systems implementing a virtual environment). A local zone served by a local mixer is also configurable to have one or more indirect neighbors, in which a neighbor mixer mixes audio from its own audio streams with an audio stream received from another neighbor mixer and passes the result to yet another neighbor mixer or to the local mixer.

At the local device of the user, rendering module 330 renders the local audio stream and the neighbor audio stream. Rendering an audio stream includes spatializing the audio stream, i.e., playing the audio stream as if the stream were positioned at a specific point in three-dimensional space around the user. If a user is wearing a headset or AR glasses with left and right ear inputs, spatializing the audio stream includes generating a left ear input and a right ear input of spatialized audio. If a user's local device includes stereo outputs or multi-channel outputs (e.g., five or more outputs, as in a home theater system), spatializing the audio stream includes generating per-channel outputs of spatialized audio. One implementation of module 330 implements a spatialized audio stream in which nearby audio sources are rendered more clearly than more distant audio sources and audio sources a user is looking at are rendered more clearly than audio sources the user is not looking at (e.g., audio sources behind the user). If a user is using an output system with multiple speakers, spatializing the audio stream includes generating suitable outputs from each speaker. Techniques for rendering spatialized audio are presently available. Additional rendering formats are also possible.

For example, in one use case, a virtual concert, a user might have ten friends in the immediate vicinity. Audio from the ten friends might be implemented as local audio sources sent to a local mixer and thence to the user's local device for rendering. Audio from a group of neighbors to the user's left (e.g., cheering for the singer) is sent from neighbor audio sources to a neighbor mixer, which sends a neighbor mix to the local mixer and thence to the user's local device for rendering. Audio from a group of neighbors to the user's right (e.g., singing along) is sent from neighbor audio sources to another neighbor mixer, which sends another neighbor mix to the local mixer and thence to the user's local device for rendering. As a result, the user can enjoy the concert and talk to the friends, but at the same time, feel immersed in the crowd with real-time, specific feedback such as the set of people on the user's left cheering for the singer while on the user's right people are singing along.

Application 222 detects a change in user position from a first zone including a first plurality of local audio sources towards a second zone including a second plurality of local audio sources. During the detected change in user position, module 330 executing at a local device renders an existing neighbor audio stream as well as a cross-fade between a first local audio stream (including a first audio mix generated by a first local audio mixer from the first plurality of local audio sources) and a second local audio stream (including a second audio mix generated by a second local audio mixer from the second plurality of local audio sources).

In another example configuration, module 330 executing at a local device renders a local audio stream described elsewhere herein (e.g., in an audience zone) and a stage audio stream (from a stage zone). The stage audio stream includes an audio mix generated by a stage audio mixer from one or more stage audio sources and outputs from audience mixers mixing local audio sources in each audience zone. This example configuration might be used, for example, for a virtual concert, to ensure that each presenter, singer, or musical instrument on the stage can be heard by audience members while adding enough audio from audience members to produce an “in the audience” experience for a user. The stage zone might be fixed (e.g., incorporating all of the stage or all of a playing field) or move with a presenter (e.g., if the presenter leaves the stage to move around the audience). In another example configuration, an embodiment executing at a local device renders a local audio stream, the stage audio stream, and one or more neighbor mixes (as described elsewhere herein).

In another example configuration, module 330 executing at a local device renders a plurality of nearest audio streams. Each nearest audio stream includes an audio mix generated by an audio mixer from a plurality of audio sources in a zone of a nearest neighbors to the local device. This example configuration might be used, for example, to implement a virtual environment in which a user moves around and experiences audio from other users that are sufficiently close to the user. For example, if a user is currently in zone 2 and a user's nearest neighbors are in zones 1, 2, 3, and 4, the user's local device might receive mixes from the mixer for zone 1, the mixer for zone 2, the mixer for zone 3, and the mixer for zone 4. One implementation of application 222 uses a predetermined zone map. Another implementation of application 222 adjusts zone sizes and locations to accommodate users'locations in the virtual environment. For example, application 222 might shrink a zone's area in a location that is drawing a crowd and might expand a zone's area in a location that currently includes a sparser population.

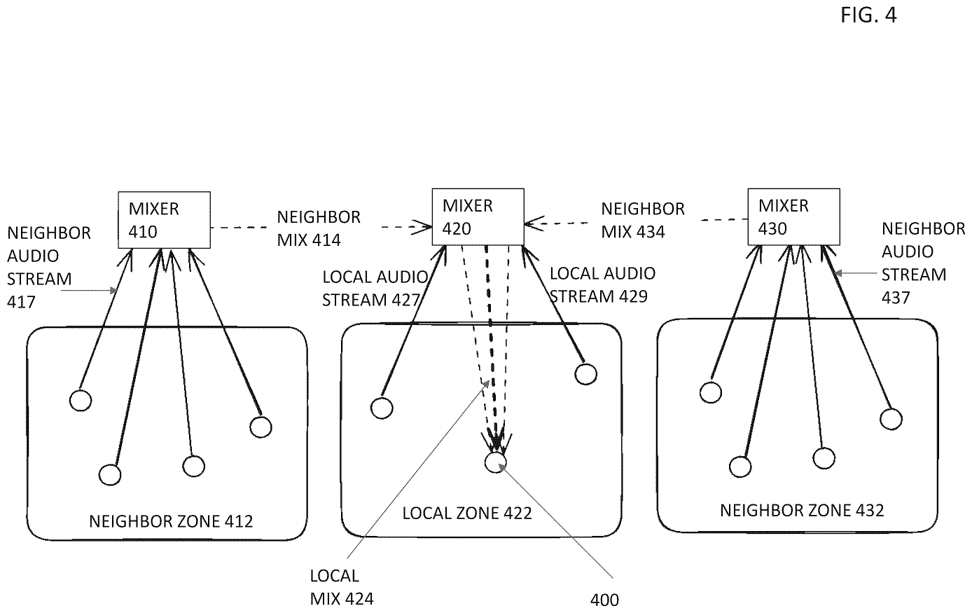

FIG. 4 depicts an example configuration of virtual environment scaling using audio zoning, in accordance with an illustrative embodiment. The example can be executed using application 222 in FIG. 2.

As depicted, small circles represent local devices such as 400, where audio for a user is being rendered. The user, along with other local audio sources, is in local zone 422. A non-local zone is a zone in which the user is not present. Examples of a non-local zone are neighbor zones 412 and 432, which include one or more other users the first user does not interact with one-on-one but are still close enough to the user in the virtual environment that the user expects to hear audio from the neighbor zone when experiencing the virtual environment.

Instances of application 222 executing at local device within local zone 422 generate outgoing local audio streams 427 and 429. Local audio mixer 420 receives local audio streams 427 and 429. Similarly, an instance of application 222 executing at a local device in neighbor zone 412 generates outgoing audio streams (e.g., neighbor audio stream 417) and sends the outgoing audio streams to neighbor audio mixer 410. An instance of application 222 executing at a local device in neighbor zone 432 generates outgoing audio streams (e.g., neighbor audio stream 437) and sends the outgoing audio streams to neighbor audio mixer 430.

Mixer 410 generates neighbor mix 414 from the audio streams received from neighbor audio sources (including neighbor audio stream 417) and sends neighbor mix 414 to one or more other mixers, such as mixer 420, as an audio stream. Mixer 430 generates neighbor mix 434 from the audio streams received from neighbor audio sources (including neighbor audio stream 437) and sends neighbor mix 434 to one or more other mixers, such as mixer 420, as an audio stream.

Mixer 420 generates a local audio mix 424 from neighbor mixes 414 and 434 and local audio streams 427 and 429. Mixer 420 sends local audio mix 424, as an audio stream, to 400. At 400, application 222 renders local audio mix 424.

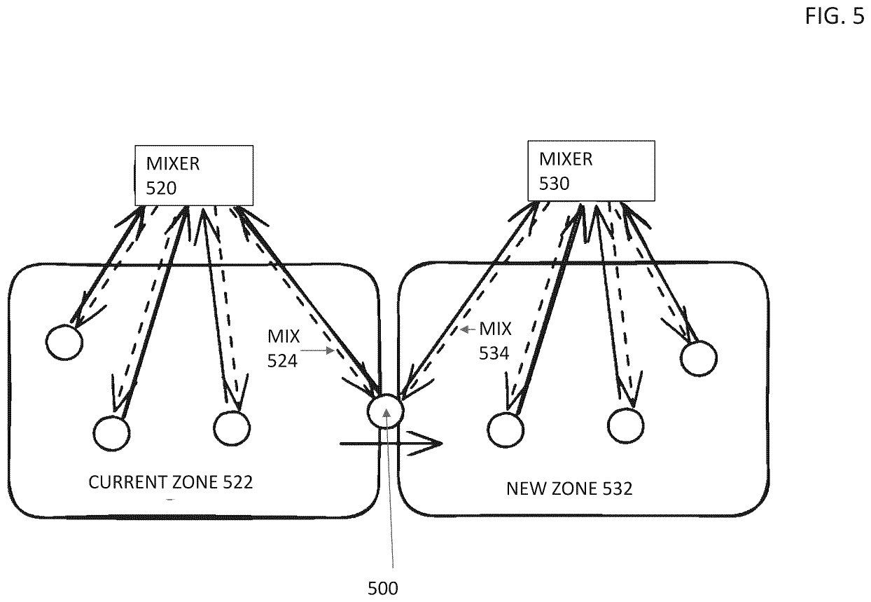

FIG. 5 depicts another example configuration of virtual environment scaling using audio zoning, in accordance with an illustrative embodiment. The example can be executed using application 222 in FIG. 2.

As depicted, local device 500 is in current zone 522, receiving mix 524 from mixer 520. As a user associated with 500 moves towards new zone 522, application 222 renders an existing neighbor audio stream (not shown) as well as a cross-fade between mix 524 and mix 534 (generated by mixer 530 from local audio sources in new zone 522.

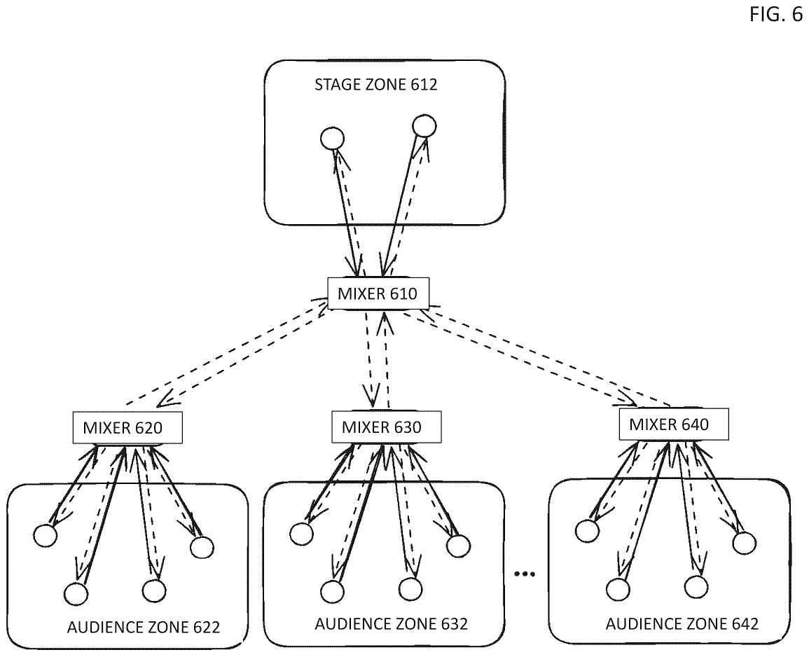

FIG. 6 depicts another example configuration of virtual environment scaling using audio zoning, in accordance with an illustrative embodiment. The example can be executed using application 222 in FIG. 2.

As depicted, application 222 executing at a local device renders a local audio stream (e.g., in audience zones 622, 632, and 642) and a stage audio stream (from stage zone 612). The stage audio stream includes an audio mix generated by mixer 610 from one or more stage audio sources and outputs from mixers 620, 630, and 640 mixing local audio sources in each audience zone. This example configuration might be used, for example, for a virtual concert, to ensure that each presenter, singer, or musical instrument on the stage can be heard by audience members while adding enough audio from audience members to produce an “in the audience” experience for a user.

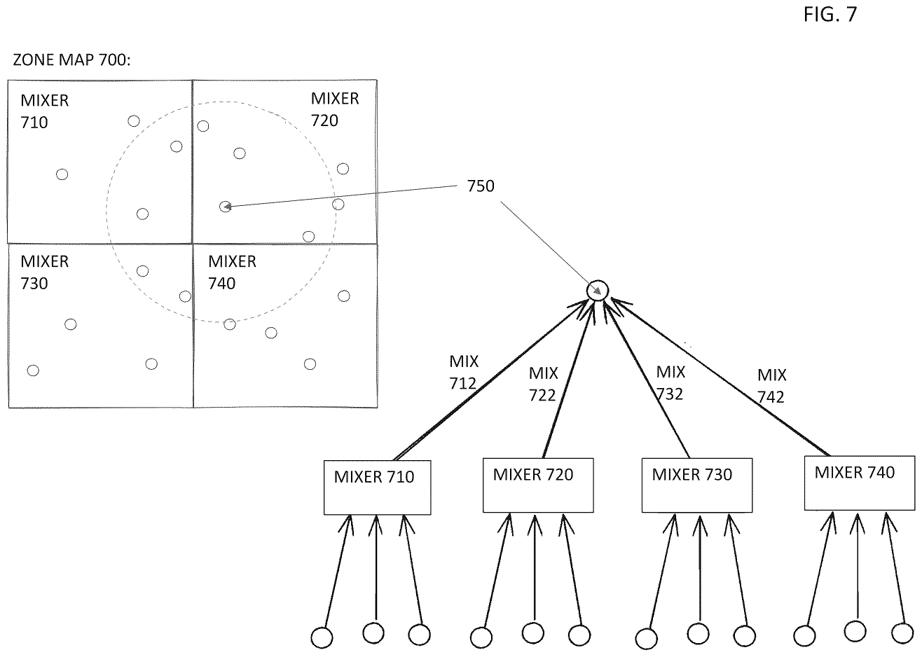

FIG. 7 depicts another example configuration of virtual environment scaling using audio zoning, in accordance with an illustrative embodiment. The example can be executed using application 222 in FIG. 2.

Zone map 700 depicts audio sources each feeding one of mixers 710, 720, 730 and 740, depending on which zone an audio source is in. A user associated with local device 750 is currently in mixer 720's zone the user's nearest neighbors are in the zones served by mixers 710, 720, 730 and 740. Thus, mixer 720 receives mix 712 from mixer 710, mix 722 from mixer 720, mix 732 from mixer 730, and mix 742 from mixer 740.

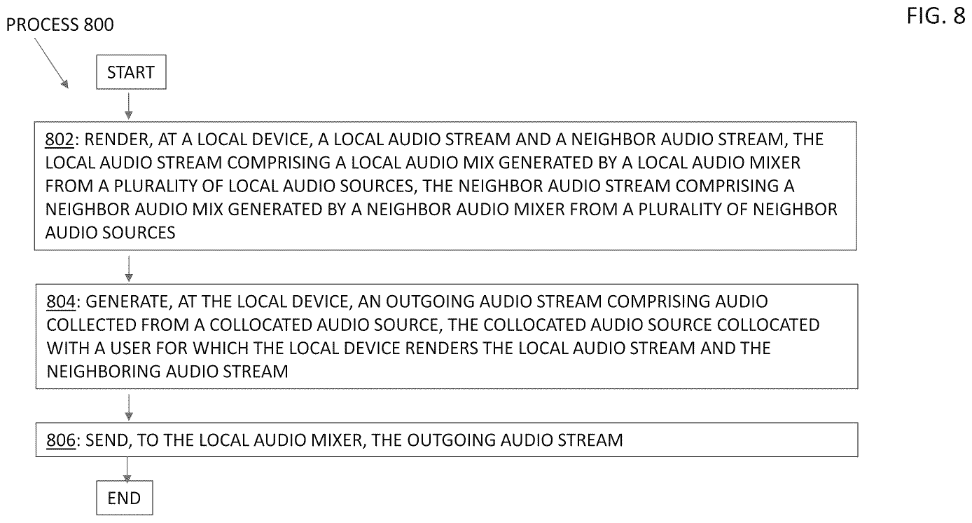

FIG. 8 depicts a flowchart of an example process for virtual environment scaling using audio zoning. in accordance with an illustrative embodiment. Process 800 can be implemented in application 222 in FIG. 2.

At block 802, the process renders, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources. At block 804, the process generates, at the local device, an outgoing audio stream comprising audio collected from a collocated audio source, the collocated audio source collocated with a user for which the local device renders the local audio stream and the neighboring audio stream. At block 806, the process sends, to the local audio mixer, the outgoing audio stream. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
rendering, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources;
generating, at the local device, an outgoing audio stream comprising audio collected from a collocated audio source, the collocated audio source collocated with a user for which the local device renders the local audio stream and the neighboring audio stream; and
sending, to the local audio mixer, the outgoing audio stream.

2. The computer-implemented method of claim 1, wherein the neighbor audio stream is in a mono format.

3. The computer-implemented method of claim 1, wherein the local audio stream is in an ambisonic format.

4. The computer-implemented method of claim 1, wherein rendering the local audio stream and the neighbor audio stream comprises generating a left ear audio input and a right ear audio input.

5. The computer-implemented method of claim 1, further comprising:
detecting a change in user position from a first zone comprising the plurality of local audio sources towards a second zone comprising a plurality of second local audio sources; and
rendering, at the local device, during the detected change in user position, the neighbor audio stream and a cross-fade between the local audio stream and a second local audio stream, the second local audio stream comprising a second audio mix generated by a second local audio mixer from the plurality of second local audio sources.

6. The computer-implemented method of claim 1, further comprising:
rendering, at the local device, the local audio stream and a stage audio stream, the stage audio stream comprising an audio mix generated by a stage audio mixer from a stage audio source.

7. The computer-implemented method of claim 1, further comprising:
rendering, at the local device, a plurality of nearest audio streams, each nearest audio stream in the plurality of nearest audio streams comprising an audio mix generated by an audio mixer from a plurality of audio sources in a zone of a nearest neighbor to the local device.

8. A non-transitory computer-readable medium storing a program, which when executed by a computer, configures the computer to:
render, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources;
generate, at the local device, an outgoing audio stream comprising audio collected from a collocated audio source, the collocated audio source collocated with a user for which the local device renders the local audio stream and the neighboring audio stream; and
send, to the local audio mixer, the outgoing audio stream.

9. The non-transitory computer-readable medium of claim 8, wherein the neighbor audio stream is in a mono format.

10. The non-transitory computer-readable medium of claim 8, wherein the local audio stream is in an ambisonic format.

11. The non-transitory computer-readable medium of claim 8, wherein rendering the local audio stream and the neighbor audio stream comprises generating a left ear audio input and a right ear audio input.

12. The non-transitory computer-readable medium of claim 8, wherein the program, when executed by the computer, further configures the computer to:
detect a change in user position from a first zone comprising the plurality of local audio sources towards a second zone comprising a plurality of second local audio sources; and
render, at the local device, during the detected change in user position, the neighbor audio stream and a cross-fade between the local audio stream and a second local audio stream, the second local audio stream comprising a second audio mix generated by a second local audio mixer from the plurality of second local audio sources.

13. The non-transitory computer-readable medium of claim 8, wherein the program, when executed by the computer, further configures the computer to:
render, at the local device, the local audio stream and a stage audio stream, the stage audio stream comprising an audio mix generated by a stage audio mixer from a stage audio source.

14. The non-transitory computer-readable medium of claim 8, wherein the program, when executed by the computer, further configures the computer to:
render, at the local device, a plurality of nearest audio streams, each nearest audio stream in the plurality of nearest audio streams comprising an audio mix generated by an audio mixer from a plurality of audio sources in a zone of a nearest neighbor to the local device.

15. A system comprising:
a processor; and
a non-transitory computer readable medium storing a set of instructions, which when executed by the processor, configure the system to:
render, at a local device, a local audio stream and a neighbor audio stream, the local audio stream comprising a local audio mix generated by a local audio mixer from a plurality of local audio sources, the neighbor audio stream comprising a neighbor audio mix generated by a neighbor audio mixer from a plurality of neighbor audio sources;
generate, at the local device, an outgoing audio stream comprising audio collected from a collocated audio source, the collocated audio source collocated with a user for which the local device renders the local audio stream and the neighboring audio stream; and
send, to the local audio mixer, the outgoing audio stream.

16. The system of claim 15, wherein the neighbor audio stream is in a mono format.

17. The system of claim 15, wherein the local audio stream is in an ambisonic format.

18. The system of claim 15, wherein rendering the local audio stream and the neighbor audio stream comprises generating a left ear audio input and a right ear audio input.

19. The system of claim 15, wherein the set of instructions, which when executed by the processor, further configure the system to:
detect a change in user position from a first zone comprising the plurality of local audio sources towards a second zone comprising a plurality of second local audio sources; and
render, at the local device, during the detected change in user position, the neighbor audio stream and a cross-fade between the local audio stream and a second local audio stream, the second local audio stream comprising a second audio mix generated by a second local audio mixer from the plurality of second local audio sources.

20. The system of claim 15, wherein the set of instructions, which when executed by the processor, further configure the system to:
render, at the local device, the local audio stream and a stage audio stream, the stage audio stream comprising an audio mix generated by a stage audio mixer from a stage audio source.
